(19) United States
(12) Patent Application Publication
(10) Pub. No.: US 2024/0099307 A1
(43) Pub. Date: Mar. 28, 2024

(54) ANTIMICROBIAL COMPOSITE FILM AND METHOD FOR MAKING THE SAME

(71) Applicant: CORNING INCORPORATED, CORNING, NY (US)

(72) Inventors: Bavani Balakrisnan, Corning, NY (US); Charles Brandenburg, Wellsboro, PA (US); Douglas Edmon Goforth, Painted Post, NY (US); Cassandra Ann Haynes, Sayre, PA (US); Insik Jeon, Novi, MI (US); Jenny Kim, Sunnyvale, CA (US); Joydeep Lahiri, Corning, NY (US); Jin Liu, Lincoln, RI (US); Kevin Robert McCarthy, Horseheads, NY (US); Michael Lesley Sorensen, Waverly, NY (US)

(21) Appl. No.: 18/275,739

(22) PCT Filed: Feb. 4, 2022
(86) PCT No.: PCT/US2022/015177

§ 371 Date: Aug. 3, 2023

Related U.S. Application Data
(60) Provisional application No. 63/148,004, filed on Feb. 10, 2021.

(51) Int. Cl. A01N 59/20; A01N 25/10; A01P 1/00; C09D 5/14; C09D 175/04; C09D 183/04

(52) U.S. Cl. CPC A01N 59/20; A01N 25/10; A01P 1/00; C09D 5/14; C09D 175/04; C09D 183/04

(57) ABSTRACT

A method for making an antimicrobial composite film can include forming a first coating layer by applying a first coating material on a substrate and forming a second coating layer by applying a second coating material on the first coating layer. The first coating material can comprise a first resin. The second coating material can comprise an antimicrobial material in a second resin or a dispersion. The first coating material can have a lower concentration of the antimicrobial material than the second coating material. The first and second coating layers can cooperatively define a composite film. The antimicrobial material can be asymmetrically dispersed in the composite film such that the antimicrobial material is concentrated closer to the outer surface of the composite film than to the inner surface of the composite film.

### CROSS REFERENCE TO RELATED APPLICATIONS

This application claims the benefit of priority under 35 U.S.C. § 119 of U.S. Provisional Application No. 63/148,004, filed on Feb. 10, 2021, the content of which is relied upon and incorporated herein by reference in its entirety.

### BACKGROUND

### 1. Field

This disclosure relates to antimicrobial composite films and methods for making such films.

### 2. Technical Background

Various objects can be exposed to undesired contaminants such as bacteria, viruses, mildew, mold, fungi, algae, and the like. Exposure to these contaminants can render the objects visually unattractive or unsuitable for a particular purpose, or even present a health hazard. Therefore, it can be desirable to mitigate the ability of the undesired contaminants to thrive once in contact with the surface of the object.

### SUMMARY

Disclosed herein are antimicrobial composite films and methods for making such films.

Disclosed herein is a method for making an antimicrobial composite film. A first coating layer can be formed by applying a first coating material to a surface of a substrate. The first coating material can comprise a first resin. A second coating layer can be formed by applying a second coating material to a surface of the first coating layer such that the first coating layer is disposed between the substrate and the second coating layer. The second coating material can comprise a second resin. The second coating material can comprise an antimicrobial material dispersed in the second resin. A concentration of the antimicrobial material in the first coating material can be less than a concentration of the antimicrobial material in the second coating material. The first coating layer and the second coating layer can cooperatively define a composite film disposed on the substrate. The composite film can comprise an outer surface and an inner surface. The outer surface of the composite film can be disposed farther from the substrate than the inner surface of the composite film. The antimicrobial material can be asymmetrically dispersed in the composite film such that the antimicrobial material is concentrated closer to the outer surface of the composite film than to the inner surface of the composite film.

Disclosed herein is a method for making an antimicrobial composite film. A first coating layer can be formed by applying a first coating material to a surface of a substrate. The first coating material can comprise a resin. A second coating layer can be formed by applying a second coating material to a surface of the first coating layer such that the first coating layer is disposed between the substrate and the second coating layer. The second coating material can comprise a dispersion comprising an antimicrobial material. A concentration of the antimicrobial material in the first coating material can be less than a concentration of the antimicrobial material in the second coating material. The first coating layer and the second coating layer can cooperatively define a composite film disposed on the substrate. The composite film can comprise an outer surface and an inner surface. The outer surface of the composite film can be disposed farther from the substrate than the inner surface of the composite film. The antimicrobial material can be asymmetrically dispersed in the composite film such that the antimicrobial material is concentrated closer to the outer surface of the composite film than to the inner surface of the composite film.

Disclosed herein is an antimicrobial composite film comprising a polymeric matrix and an antimicrobial material asymmetrically dispersed in the polymeric matrix such that the antimicrobial material is concentrated closer to an outer surface of the composite film than to an inner surface of the composite film.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIGS. 1-3 schematically illustrate some embodiments of a method for making an antimicrobial composite film.

FIGS. 4-5 are top and cross sectional scanning electron microscope (SEM) images, respectively, of some embodiments of a composite film prepared as described in Example 7.

FIGS. 6-7 are top and cross sectional SEM images, respectively, of some embodiments of a composite film prepared as described in Example 6.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

As used herein, the term “antimicrobial” means a material or surface that kills or inhibits the growth of microbes including bacteria, viruses, mildew, mold, algae, and/or fungi. The term antimicrobial does not mean the material or surface kills or inhibits the growth of all of such families of microbes or all species of microbes within such families, but that the material or surface kills or inhibits the growth of one or more species of microbes from one or more of such families.

As used herein, the term “log reduction” means the negative value of log(Ca/Co), where Ca is the colony form unit (CFU) number of the antimicrobial surface and Co is the CFU number of the control surface that is not an antimicrobial surface. As an example, a 3 log reduction equals about 99.9% of the microbes killed and a 5 log reduction equals about 99.999% of microbes killed. The log reduction can be measured according to the procedures outlined in the United States Environmental Protection Agency Office of Pesticide Programs Protocol for the Evaluation of Bactericidal Activity of Hard, Non-porous Copper Containing Surface Products, dated 29 Jan. 2016.

In embodiments in which an antimicrobial coating is configured to have biocidal properties with respect to bacteria, suitable examples of bacteria include Staphylococcus aureus, Enterobacter aerogenes, Pseudomonas aeruginosa, Methicillin Resistant Staphylococcus aureus, E. coli, and mixtures thereof.

In various embodiments, a method for making an antimicrobial composite film comprises forming a first coating layer by applying a first coating material to a surface of a substrate. The first coating material can comprise a first resin. A second coating layer can be formed by applying a second coating material to a surface of the first coating layer such that the first coating layer is disposed between the substrate and the second coating layer. The second coating material can comprise an antimicrobial material. In some embodiments, the second coating material comprises a second resin. Additionally, or alternatively, the second coating material comprises a dispersion comprising the antimicrobial material. For example, the dispersion comprises an aqueous dispersion (e.g., comprising water as the continuous medium) or a non-aqueous dispersion (e.g., comprising an organic solvent as the continuous medium). In some embodiments, the antimicrobial material and/or the dispersion comprising the antimicrobial material can be dispersed in the second resin to form the second coating material. The first coating material can have a lower concentration of the antimicrobial material than the second coating material. For example, the first coating material can be substantially free of the antimicrobial material. The first coating layer and the second coating layer can cooperatively define a composite film disposed on the substrate. The composite film can comprise an outer surface and an inner surface, wherein the outer surface of the composite film is disposed farther from the substrate than the inner surface of the composite film. The antimicrobial material can be asymmetrically dispersed in the composite film such that the antimicrobial material is concentrated closer to the outer surface of the composite film than to the inner surface of the composite film.

The antimicrobial films described herein can have improved performance compared to antimicrobial films in which an antimicrobial filler is dispersed homogenously throughout the film. For example, the asymmetric dispersion of the antimicrobial material such that the antimicrobial material is concentrated closer to the outer surface of the composite film can enable improved antimicrobial performance because a greater proportion of the antimicrobial material in the composite film can be available at the outer surface of the composite film for interacting with microbes present on the outer surface of the composite film. Additionally, or alternatively, the concentration of the antimicrobial material near the outer surface of the composite film can be increased without a corresponding increase in the bulk concentration of the antimicrobial material in the composite film, or the bulk concentration of the antimicrobial material in the composite film can be reduced without a corresponding reduction in the concentration of the antimicrobial material near the outer surface of the composite film. Such a reduced ratio of the bulk concentration of the antimicrobial material in the composite film to the concentration of the antimicrobial material near the outer surface of the composite film can enable the composite film to exhibit improved mechanical properties by avoiding the negative effects that can be associated with high loading of filler materials in polymers.

To achieve good antimicrobial efficacy, a relatively high loading of antimicrobial material can be used in a composite film. However, such a high loading can adversely affect the mechanical properties of the polymer and/or can increase the cost of the composite film. Antimicrobial material distributed in the interior of the polymer matrix can exhibit limited antimicrobial efficacy compared to antimicrobial material distributed at the surface of the polymer material. Such limited antimicrobial efficacy can result from a lack of conducting channels from the interior of the composite film to the film surface. The composite films described herein can have asymmetric distribution of the antimicrobial material preferentially toward the film surface. Such highly surface-oriented antimicrobial composite films can enable efficient and direct bacterial or viral contact for improved antimicrobial efficacy.

A two-step coating process as described herein can include a first base resin coat followed by a second coat using a formulation that contains the antimicrobial material, either in a resin or a dispersion. The first base coat can be gently dried or cured by heat or UV light prior to the second top-coat. The second top-coat can be applied on the base coat surface, followed by final curing, depending on resins and curing initiators, by heat or UV light. In this two-step process, resins for the base and the top-coat can be the same or different. Using the same resin in the base and the top-coat can help to achieve higher miscibility and adhesion of layers.

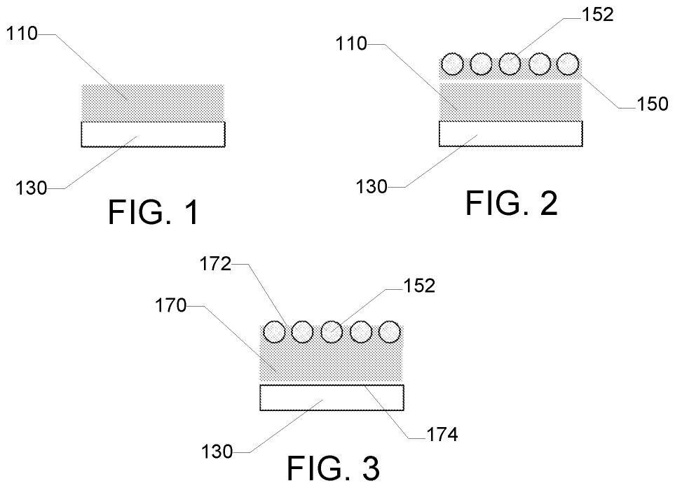

FIGS. 1-3 schematically illustrate some embodiments of a method for making an antimicrobial composite film. In some embodiments, the method comprises forming a first coating layer by applying a first coating material to a surface of a substrate. For example, a first coating layer 110 can be formed on a surface of a substrate 130 as shown in FIG. 1. Substrate 130 can be any article to be coated with an antimicrobial composite film as described herein. For example, substrate 130 can be any article that may benefit from a coating exhibiting antimicrobial efficacy. In various embodiments, substrate 130 can be planar or non-planar and solid or porous. In some embodiments, substrate 130 is an article subject to frequent touching. Some examples of substrate 130 include, but are not limited to, consumer electronics products, kiosks, tables, countertops, desks, walls, doors, handrails, fibers, woven or non-woven textiles, conveyance (e.g., automobile, aircraft, ship, or train) interiors or exteriors, or any other object.

In some embodiments, the first coating material comprises a first resin. In various embodiments described herein, a resin can comprise monomers, oligomers, polymers, or combinations thereof. For example, the resins described herein can comprise one or more of phenolic resin, urea formaldehyde resin, epoxy resin, unsaturated polyester, polyurethane resin, silicone resin, alkyd resin, acrylic resin (e.g., acrylic ester), epoxy resin, polyethylene (PE), polyvinyl chloride (PVC), polystyrene (PS), polyvinyl acetate (PVAC), polypropylene (PP), polymethacrylic acid (PMMA), acrylonitrile butadiene styrene (ABS), polyimide, polyamide, polyvinylpyrrolidone (PVP), polycarbonate, fluoropolymers, copolymers thereof, or combinations thereof. A resin in its uncured or partially cured state can have a sufficiently low amount of crosslinking and/or a sufficiently short polymeric chain length, whereby the resin remains runny, soft, sticky, and/or tacky. In some embodiments, such an uncured or partially cured resin is a liquid or semi-solid that can be unset or flowable on the substrate and/or removable from the substrate (e.g., by wiping or scraping). In some embodiments, a resin can be cured, for example, by heat or exposure to ultraviolet (UV) radiation. A resin in its cured state can have a sufficiently high amount of crosslinking and/or a sufficiently long polymeric chain length, whereby the resin is hardened. In some embodiments, such a cured resin is a solid that is set on the substrate and/or adhered to the substrate. In some embodiments, a cured resin can be referred to as a polymer or a polymeric material.

In some embodiments, the method comprises forming a second coating layer by applying a second coating material to a surface of the first coating layer. For example, a second coating layer 150 can be formed on a surface of first coating layer 110 as shown in FIG. 2. First coating layer 110 can be disposed between substrate 130 and second coating layer 150. In some embodiments, the second coating material comprises a second resin, which can be the same as or different than the first resin.

In some embodiments, the second coating material of second coating layer 150 comprises an antimicrobial material 152 dispersed therein. For example, antimicrobial material 152 is dispersed in the second resin of second coating layer 150. In some embodiments, antimicrobial material 152 comprises a plurality of copper-containing particles. For example, antimicrobial material 152 comprises copper-containing glass particles, copper oxide particles, copper metal particles, copper salt (e.g., copper halide, copper acetate, or copper sulfate) particles, or a combination thereof.

In some embodiments, a concentration of antimicrobial material 152 in the first coating material of first coating layer 110 is less than a concentration of the antimicrobial material in the second coating material of second coating layer 150. For example, the first coating material of first coating layer 110 can be substantially free of antimicrobial material 152 as shown in FIG. 2. In some embodiments, the concentration of antimicrobial material 152 in the first coating material of first coating layer 110 can be at most about 1%, at most about 0.5%, at most about 0.1%, or at most about 0.01% by weight.

In some embodiments, a thickness of second coating layer 130 is about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, or any ranges defined by the listed values. Additionally, or alternatively, the thickness of second coating layer can be based on the size of the particles of antimicrobial material 152. For example, the thickness of second coating layer 130 is within about 50%, within about 40%, within about 30%, within about 20%, or within about 10% of a median diameter of the particles of antimicrobial material 152. In some embodiments, the median diameter is the D50 particle size of the particles of antimicrobial material 152, wherein the diameter of a particle is the largest dimension of the particle. Such a thickness of second coating layer 130 based on the size of the particles of antimicrobial material 152 can enable the antimicrobial material to be held in place within the second coating layer but also close enough to the outer surface to exhibit sufficient antimicrobial efficacy as described herein. Additionally, or alternatively, matching the thickness of second coating layer 130 to the size of the particles of antimicrobial material 152 can enable a relatively high loading of the antimicrobial material near the surface of the second coating layer with a relatively low bulk loading of the antimicrobial material in the composite film as described herein.

In some embodiments, first coating layer 110 and second coating layer 150 cooperatively define a composite film 170 disposed on substrate 130 as shown in FIG. 3. Composite film 170 can comprise an outer surface 172 and an inner surface 174. Outer surface 172 of composite film 170 can be disposed farther from substrate 130 than inner surface 174 of the composite film. In some embodiments, antimicrobial material 152 is asymmetrically dispersed in composite film 170 such that the antimicrobial material is concentrated closer to outer surface 172 of the composite film than to inner surface 174 of the composite film. For example, a concentration of antimicrobial material 152 is greater in a surface region of composite film 170 disposed near outer surface 172 than in an underlying region of the composite film disposed near substrate 130. In some embodiments, the surface region of composite film extends from outer surface 172 to a depth of about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, or any ranges defined by the listed values. In some embodiments, the surface region of composite film 170 extends from outer surface 172 to a depth of about 1%, about 2%, about 3%, about 4%, about 5%, about 6%, about 7%, about 8%, about 9%, about 10%, about 15%, about 20%, about 25%, about 30%, about 35%, about 40%, about 45%, about 50% of the thickness of the composite film, or any ranges defined by the listed values.

The copper-containing particles of antimicrobial material 152 can be distributed at or near the surface of composite film 170 as shown in FIG. 3, which can enable efficient contact with surface microorganism, such as bacteria and viruses, while limiting the effect of the antimicrobial material on the brittleness of the composite film (e.g., by avoiding the brittleness that is typically associated with high filler ratio in a polymer).

In some embodiments, the method comprises at least partially curing composite film 170 (e.g., at least partially curing the first coating material of first coating layer 110 and/or at least partially curing the second coating material of second coating layer 130). For example, at least partially curing composite film 170 comprises at least one of heating the composite film (e.g., in embodiments in which the first resin and/or the second resin are thermally curable) or exposing the composite film to UV light (e.g., in embodiments in which the first resin and/or the second resin are UV curable). In some embodiments, first coating layer 110 and second coating layer 130 are bonded or fused (e.g., during curing) to form composite film 170. Curing can set composite film 170 such that antimicrobial material 152 is immobilized within the composite film (e.g., near outer surface 172). The presence and/or position of antimicrobial material 152 can enable composite film 170 to exhibit antimicrobial efficacy as described herein.

In some embodiments, the method comprises at least partially curing the first coating material of first coating layer 110 after forming the first coating layer and before forming second coating layer 130. For example, the first resin of first coating layer 110 is at least partially cured prior to forming second coating layer 130. In some embodiments, the at least partially curing the first coating material of first coating layer 110 comprises at least one of heating the first coating layer (e.g., in embodiments in which the first resin is thermally curable) or exposing the first coating layer to UV light (e.g., in embodiments in which the first resin is UV curable). At least partially curing the first coating material prior to forming second coating layer 130 can enable more efficient curing of the first coating material. For example, the heat or UV light can be applied directly to first coating layer 110 while it is uncovered or exposed and before it is covered by second coating layer 130, which can help to improve the efficiency of the curing process.

In some embodiments, the first coating material is not fully cured prior to forming second coating layer 130. Such an uncured or partially cured first coating material can help to improve adhesion between first coating layer 110 and second coating layer 130. For example, such uncured or partially cured first coating material can crosslink or otherwise bond to the second coating material during curing of composite film 170 (e.g., during final curing) as described herein. Additionally, or alternatively, such uncured or partially cured first coating material can remain sticky or tacky, which can improve adhesion during application of the second coating material to the surface of first coating layer 110.

In some embodiments, first coating layer 110 and second coating layer 150 are fused to form a monolithic polymer matrix of composite film 170 as shown in FIG. 3. For example, the first resin of the first coating material and the second resin of the second coating material can be substantially the same, whereby the polymer matrices of first coating layer 110 and second coating layer 150 are substantially indistinguishable in composite film 170 (e.g., after final curing). In some embodiments, first coating layer 110 and second coating layer 150 are joined or otherwise adhered, but form independent polymer matrices of composite film 170. For example, the first resin of the first coating material and the second resin of the second coating material can be different and/or first coating layer 110 can be cured prior to formation of second coating layer 150, whereby the polymer matrices of the first coating layer and the second coating layer are distinguishable or independent in composite film 170 (e.g., after final curing).

In some embodiments, the second coating material comprises a dispersion comprising antimicrobial material 152. For example, the particles of antimicrobial material 152 can be suspended in a continuous medium of such dispersion. Such a dispersion can be applied as the second coating material (e.g., without the second resin) to form second coating layer 150 or mixed with the second resin to form the second coating material and then applied to first coating layer 110 to form the second coating layer. In some embodiments, the method comprises forming the second coating material by mixing the dispersion comprising antimicrobial material 152 with the second resin. For example, the dispersion comprises an aqueous dispersion (e.g., comprising water as the continuous medium). Alternatively, the dispersion comprises a non-aqueous dispersion (e.g., comprising a non-aqueous solvent as the continuous medium). In some embodiments, the dispersion comprises a thickener, a dispersant, other additive materials, or a combination thereof as described herein.

In some embodiments, antimicrobial material 152 comprises copper-containing particles. For example, the copper-containing particles comprise copper-containing glass particles, copper oxide particles, copper metal particles, copper salt (e.g., copper halide, copper acetate, or copper sulfate) particles, or a combination thereof. A median size of the copper-containing particles can be in a range of about 1 μm to about 15 μm, about 3 μm to about 8 μm, about 4 μm to about 6 μm, less than, equal to, or greater than about 1 μm, 2 μm, 3 μm, 4 μm, 5 μm, 6 μm, 7 μm, 8 μm, 9 μm, 10 μm, 11 μm, 12 μm, 13 μm, 14 μm, or about 15 μm. The median size can be determined by analyzing the major dimension of the individual copper-containing particles. The major dimension, on an individual basis, can be a measurement of the diameter, width, or length of the individual copper-containing particles.

In some embodiments, the dispersion comprises the copper-containing particles homogenously distributed in a dispersant, a thickener, or a mixture thereof. A concentration of the copper-containing particles in the dispersion can be in a range of about 3 wt % to about 88 wt %, about 10 wt % to about 87 wt %, about 42 wt % to about 85 wt %, less than, equal to, or greater than about 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, or about 88 wt %. In some embodiments, the concentration of the copper-containing particles in the dispersion can be determined such that a concentration of the copper-containing particles in the second coating material is in a range of about 10 wt % to about 50 wt %, or less than, equal to, or greater than about 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, or 50 wt %.

In some embodiments, an inorganic glass portion of the copper-containing glass particles comprises one or more of SiO₂, Al₂O₃, CaO, MgO, P₂O₅, B₂O₃, K₂O, ZnO, Fe₂O₃, nanoparticles thereof, or a mixture thereof.

In some embodiments, the copper-containing glass particles comprise an inorganic glass comprising a copper component, or a Cu species. For example, the Cu species comprises Cu¹⁺, Cu⁰, and/or Cu²⁺. In some embodiments, the combined total concentration of the Cu species in the copper-containing glass is at least about 10 wt %. However, the amount of Cu²⁺ can be minimized or reduced, such that the copper-containing glass is substantially free of Cu²⁺.

In some embodiments, Cu¹⁺ ions are present on or in the surface and/or the bulk of the copper-containing glass. For example, the Cu¹⁺ ions can be present in a glass network and/or a glass matrix of the copper-containing glass. Cu¹⁺ ions present in the glass network can be atomically bonded to the atoms in the glass network. Cu¹⁺ ions present in the glass matrix can be present in the form of Cu¹⁺ crystals dispersed in the glass matrix. For example, the Cu¹⁺ crystals comprise cuprite (Cu₂O). In embodiments comprising Cu¹⁺ ions, whether in a non-crystalline form, a crystalline form, or a combination thereof, the material may be referred to herein as a copper-containing glass. In embodiments comprising Cu¹⁺ ions in a crystalline form (e.g., cuprite crystals), the copper-containing glass may also be referred to as a copper-containing glass ceramic, which is intended to refer to a specific type of glass comprising crystals, and may be formed with or without a conventional ceramming process by which one or more crystalline phases are introduced and/or generated in the glass.

The copper of the copper-containing glass particles can be present in any suitable amount. For example, a concentration of the copper can be in a range of about 5 wt % to about 80 wt % of the copper-containing glass particle, about 10 wt % to about 70 wt %, about 25 wt % to about 35 wt %, about 40 wt % to about 60 wt %, about 45 wt % to about 55 wt %, less than, equal to, or greater than about 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, or about 80 wt %. In a copper-containing glass particle, the copper portion can comprise one or more of Cu metal, Cu¹⁺, Cu²⁺, or a combination of Cu¹⁺ and Cu²⁺. The copper can be non-complexed or can have a ligand bonded thereto to form a complex.

Examples of copper-containing glasses include, without limitation, those described in U.S. Pat. No. 9,622,483, ANTIMICROBIAL GLASS COMPOSITIONS, GLASSES AND POLYMERIC ARTICLES INCORPORATING THE SAME, and International Patent Application Pub. No. 2017/132179, ANTIMICROBIAL PHASE-SEPARABLE GLASS/POLYMER ARTICLES AND METHODS FOR MAKING THE SAME, each of which is incorporated by reference herein in its entirety.

In operation, the copper from the copper-containing particles can be released into composite film 170 to interact with and kill unwanted biological contaminants such as microbes in or on the surface of the composite film. Examples of microbes that the copper can kill include Staphylococcus aureus, Enterobacter aerogenes, Pseudomonas aeruginosa, Methicillin Resistant, E. coli, Enterobacter cloacae, Acinetobacter baumannii, Enterococcus faecalis, Klebsiella pneumoniae, Klebsiella aerogenes, Staphylococcus aureus, and mixtures thereof. Examples of viruses that the copper can kill include Influenza H1N1, Adenovirus 5, and Norovirus. An example of a fungi the copper can kill includes Candida auris. The effectiveness of composite film 170 as a biocidal coating can be measured as the log reduction of the composite film. The log reduction value of composite film 170 can be relevant to its ability to kill biological organisms to which it is exposed, but can also enable antimicrobial material 152 to act as a preservative for the composite film.

According to various examples, a log reduction of composite film 170 can be at least about 2, at least about 3, at least about 4, at least about 5, at least about 6, at least about 7, at least about 8, at least about 9, at least about 10, in a range of from about 1 to about 10, about 3 to about 7, about 4 to about 6, or less than, equal to, or greater than about 1, 2, 3, 4, 5, 6, 7, 8, 9, or about 10. The log reduction value can be measured according to the procedures outlined in the United States Environmental Protection Agency Office of Pesticide Programs Protocol for the Evaluation of Bactericidal Activity of Hard, Non-porous Copper Containing Surface Products, dated 29 Jan. 2016.

In the dispersion, individual copper-containing particles can be dispersed with a dispersant, a thickener, or a mixture thereof. The components of the dispersion can be selected such that the dispersion is compatible with (e.g., soluble or miscible in) the second resin. In some embodiments, the dispersant is able to facilitate a homogenous distribution of the copper-containing particles. For example, suitable dispersants or thickeners can help to mitigate the possibility of a substantial amount of the copper-containing particles falling out of suspension as a sediment. The ability of the dispersant or thickener to help prevent sedimentation can be determined, for example, by a test such as ASTM D5590 or ASTM D2574. In some embodiments, the dispersion can be considered a stable dispersion. For example, the dispersion is free of a sediment of the copper-containing particles for a time period in a range of about 1 day to about 365 days, about 5 days to about 90 days, less than, equal to, or greater than about 1 day, 5 days, 10 days, 15 days, 20 days, 25 days, 30 days, 35 days, 40 days, 45 days, 50 days, 55 days, 60 days, 65 days, 70 days, 75 days, 80 days, 85 days, 90 days, 95 days, 100 days, 105 days, 110 days, 115 days, 120 days, 125 days, 130 days, 135 days, 140 days, 145 days, 150 days, 155 days, 160 days, 165 days, 175 days, 180 days, 185 days, 190 days, 195 days, 200 days, 205 days, 210 days, 215 days, 220 days, 225 days, 230 days, 235 days, 240 days, 245 days, 250 days, 255 days, 260 days, 265 days, 270 days, 275 days, 280 days, 285 days, 290 days, 295 days, 300 days, 305 days, 310 days, 315 days, 320 days, 325 days, 330 days, 335 days, 340 days, 345 days, 350 days, 355 days, 360 days, or about 365 days. While not so limited, examples of suitable organic dispersants can include an acrylic acid containing copolymer, a urethane, a carboxylate containing oligomer, an amine containing oligomer, a phosphate containing oligomer, a sulfonate containing oligomer, an anhydride containing oligomer, or a mixture thereof. Examples of suitable thickeners include celluloses. Examples of celluloses can include hydrophobically modified celluloses. More specific, though non-limiting, examples of suitable celluloses can include hydroxyethyl cellulose, methyl cellulose, carboxymethyl cellulose, or a mixture thereof. In some embodiments, the dispersant comprises any of the constituents mentioned herein as well as water. For example, a dispersant comprises a carboxylate containing oligomer, an amine containing oligomer, a phosphate containing oligomer, a sulfonate containing oligomer, an anhydride containing oligomer, or a mixture thereof that are dispersed in water.

In some embodiments, the dispersion comprising antimicrobial material 152 can be added to a resin to effectively deliver the antimicrobial material to the second coating material. In other embodiments, the dispersion comprising antimicrobial material 152 can be used itself as the second coating material (e.g., without the second resin). Incorporating antimicrobial material 152 into the dispersion can improve the distribution of the antimicrobial material in second coating layer 130 compared to applying the antimicrobial material alone directly to first coating layer 110.

In some embodiments, the dispersion comprises only antimicrobial material 152 and a dispersant, a thickener, or a mixture thereof. In other embodiments, the dispersion comprises one or more additional components such as, for example, a cosolvent, a pH modifier, a surfactant, a defoamer or air release agent, a rheological pigment, a stabilizer, a rheology modifier, or a mixture thereof. Examples of suitable cosolvents can include any of the aqueous or organic solvents described herein and can additionally include isopropanol, xylene, butyl acetate, or a mixture thereof.

In some embodiments, the dispersion is free or substantially free of resin. For example, the biocidal dispersion comprises less than 5%, less than 1%, less than 0.5%, or less than 0.1% by weight of resin.

In some embodiments, the dispersion comprises a pH modifier. For example, the pH modifier can be used to maintain a pH of the dispersion to be in a range of about 6 to about 9.5, about 7.5 to about 9, about 7.5 to about 8.5, less than, equal to, or greater than about 6, 6.5, 7, 7.5, 8, 8.5, 9, or about 9.5. Maintaining a pH in this range can be helpful to influence the reactivity of copper ions with other materials in the dispersion or in composite film 170. Additionally, or alternatively, the pH of the dispersion can impact the shelf life and viscosity of the dispersion.

In some embodiments, the pH modifier has a pKa in a range of about 4.7 to about 14, about 5 to about 9.5, about 6 to about 9.5, about 7 to about 9.5, less than, equal to, or greater than about 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, or about 14. The pH modifier can be present in the dispersion in a range of about 0.1 wt % to about 5 wt %, about 0.5 wt % to about 2 wt %, about 1 wt % to about 1.5 wt %, less than, equal to, or greater than about 0.1 wt %, 0.5 wt %, 1 wt %, 1.5 wt %, 2 wt %, 2.5 wt %, 3 wt %, 3.5 wt %, 4 wt %, 4.5 wt %, or about 5 wt %.

Examples of suitable pH modifiers include, but are not limited to, Group (I) hydroxides, Group (II) hydroxides, organic amines, and combinations thereof. For example, suitable pH modifiers include those selected from metal hydroxides, ammonium hydroxide, and amines, wherein the amines are amines of the formula NH₂R, wherein R is selected from the group consisting of H, OR′ or —R′—OH, wherein R′ is selected from the group consisting of —H, alkane, and alkylene. Specific further non-limiting examples of suitable pH modifiers include potassium hydroxide, sodium hydroxide, 2-amino-2-methyl-1-propanol, ammonia, 2-dimethylamino-2-methyl-1-propanol, 2-butylaminoethanol, N-methylethanolamine, 2-amino-2-methyl-1-propanol, monoisopropanolamine, monoethanolamine, N,N dimethylethanolamine, N-butyldiethanolamine, 2-amino-2-ethyl-1,3-propanediol, 2-amino-2-hydroxymethyl-1,3-propanediol, triethanolamine, or combinations thereof. Additionally, or alternatively, suitable pH modifiers include a mixture of at least one of potassium hydroxide and sodium hydroxide and at least one of 2-amino-2methyl-1-propanol and ammonia, in which at least one of potassium hydroxide and sodium hydroxide, or a mixture thereof are the major component of the pH modifier mixture. In some embodiments, the pH modifier can be free or substantially free of ammonia or amines, which can avoid undesirable interactions between such components and the copper of antimicrobial material 152.

In some embodiments, the dispersion comprises a defoamer or air release agent, which can help to avoid forming or stabilizing air bubbles within the dispersion. Air bubbles can cause undesirable oxidation of the copper of antimicrobial material 152. Some examples of the defoamer or air release agent include, but are not limited to, mineral oil, silicone, siloxane, phosphate, fatty alcohol, fatty acids or esters, polyethylene glycol, polyacrylates, or combinations thereof. In some embodiments, the defoamer or air release agent is free or substantially free of silicone, which can undesirably alter the distribution of copper. In some embodiments, the concentration of the defoamer or air release agent is in a range of about 0.5 wt % to about 40 wt % of the dispersion, about 1 wt % to about 10 wt %, less than, equal to, or greater than about 0.5 wt %, 1 wt %, 5 wt %, 10 wt %, 15 wt %, 20 wt %, 25 wt %, 30 wt %, 35 wt %, or about 40 wt %.

In some embodiments, the dispersion comprises a rheological pigment. For example, the rheological pigment comprises a clay component (e.g., attapulgite, laponite, bentonite, or a combination thereof), a fumed silica, or a combination thereof. In some embodiments, a concentration of the rheological pigment in the dispersion is in a range of about 0.5 wt % to about 40 wt %, about 1 wt % to about 10 wt %, less than, equal to, or greater than about 0.5 wt %, 1 wt %, 5 wt %, 10 wt %, 15 wt %, 20 wt %, 25 wt %, 30 wt %, 35 wt %, or 40 wt %. In some embodiments, the rheological pigment can be part of a rheology modifier or thickener component of the dispersion. For example, a concentration of the rheology modifier in the dispersion is in a range of about 0.1 wt % to about 5 wt %, about 0.5 wt % to about 2 wt %, about 0.7 wt % to about 1.5 wt %, about 1 wt % to about 1.25 wt %, less than, equal to, or greater than about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.1 wt %, 2.2 wt %, 2.3 wt %, 2.4 wt %, 2.5 wt %, 2.6 wt %, 2.7 wt %, 2.8 wt %, 2.9 wt %, 3 wt %, 3.1 wt %, 3.2 wt %, 3.3 wt %, 3.4 wt %, 3.5 wt %, 3.6 wt %, 3.7 wt %, 3.8 wt %, 3.9 wt %, 4 wt %, 4.1 wt %, 4.2 wt %, 4.3 wt %, 4.4 wt %, 4.5 wt %, 4.6 wt %, 4.7 wt %, 4.8 wt %, 4.9 wt %, or about 5 wt %. Examples of suitable rheological modifiers include, without limitation, a thickener comprising any of the rheological pigments described herein, hydroxyethyl cellulose, methyl cellulose, carboxymethyl cellulose, hydroxyethylcellulose, an alkali swellable emulsion, a hydrophobically modified ethoxylated urethane, hydrophobically modified analogues, natural or synthetic gums thereof, or a combination thereof.

In some embodiments, the rheology modifier controls a viscosity of the dispersion. For example, the viscosity of the dispersion is in a range of about 70 KU to about 130 KU, about 75 KU to about 120 KU, about 80 KU to about 115 KU, about 90 KU to about 110 KU, about 95 KU to about 105 KU, less than, equal to, or greater than about 70 KU, 75 KU, 80 KU, 85 KU, 90 KU, 95 KU, 100 KU, 105 KU, 110 KU, 115 KU, 120 KU, 125 KU, or about 130 KU. The viscosity can be measured using any suitable instrument such as, for example, a Brookfield KU-2 viscometer. Other rheological properties of the dispersion that can be controlled can include the ability for the dispersion to be resistant to settling and syneresis during storage.

In some embodiments, the dispersion comprises a stabilizer. For example, the stabilizer comprises an organophosphate, an ammonium phosphate, a potassium tripolyphosphate, or a combination thereof. A concentration of the stabilizer in the dispersion can be in a range of about 0.5 wt % to about 20 wt %, about 2 wt % to about 10 wt %, less than, equal to, or greater than about 0.5 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or about 20 wt %.

The dispersion can be prepared according to various methods. For example, the components of the dispersion described herein can be combined into a dispersion precursor, which can be mixed for a determined mixing time to form the dispersion. The dispersion can be mixed at any suitable temperature including, for example, about room temperature (e.g., 25° C.). After preparation, the dispersion can be mixed with another component (e.g., the second resin) to form the second coating material or used as the second coating material (e.g., applied directly to first coating layer 110) to form composite film 170 as described herein.

### EXAMPLES

Various embodiments will be further clarified by the following examples.

### Examples 1-9

A 6 in by 6 in square glass substrate was secured via vacuum to the surface of a YiHUA 946A screen separator. The temperature was set at 50° C. A bead of water-based thermally-curable polyurethane resin commercially available under the tradename Eleglas™ from Axalta Coating Systems (Philadelphia, Pennsylvania, U.S.A.) was used as the first resin of the first coating material and applied along the upper edge of the glass and subsequently drawn down using a 1 mil applicator commercially available under the tradename Bird Film Applicator® from Bird Film Applicator, Inc. (Camano Island, Washington, U.S.A.) to form the first coating layer on the glass substrate.

A dispersion comprising an antimicrobial material was formed using the following process. 10 g of copper-containing particles and 1 g of a hydrophobically modified hydroxyethylcellulose thickener commercially available under the tradename Natrosol™ plus 330 PA from Ashland Global Specialty Chemicals Inc. (Wilmington, Delaware, U.S.A.) were added to a container. In Examples 1-2, the copper-containing particles were Cu₂O particles. In Examples 3-9, the copper-containing particles were copper-containing glass particles. 88.9 g of water and 0.1 g of a solvent-free dispersant commercially available under the tradename DISPERBYK-145 from BYK-Chemie GmbH (Wesel, Germany) were added to the container. The contents of the container were thoroughly mixed by shaking and left in a rotor to mix continuously for 1-2 hr until visible thickening was observed.

In Examples 1-6, the dispersion was mixed with a second resin, Eleglas™, to form the second coating material. In Example 7, the dispersion was used itself as the second coating material without any second resin. In Examples 8-9, the dispersion was mixed with the second resin, Eleglas™ and a silica filler commercially available under the tradename Nyacol® DP5820 from NYACOL Nano Technologies, Inc. (Ashland, Massachusetts, U.S.A.), to form the second coating material. Table 1 shows the relative amounts of the various components of the second coating material.

A bead of the second coating material comprising the antimicrobial material was applied along the same edge of the first coating layer on the glass substrate and subsequently drawn down using a 1.5 mil Bird Film Applicator® to form the second coating layer on the first coating layer. The vacuum was released, and the glass substrate with the composite film disposed thereon was removed from the screen separator and then placed in a 120° C. oven for 30 minutes to cure the polyurethane coating forming the composite film.

### Example 10

A 6 in by 6 in square glass substrate was secured via vacuum to the surface of a YiHUA 946A screen separator. The temperature was set at 50° C. A bead of UV-curable polysiloxane resin commercially available under the tradename SFH2950 from Luvantix ADM Co., Ltd. (Daejeon, Korea) was used as the first resin of the first coating material and applied along the upper edge of the glass and subsequently drawn down using a 1 mil Bird Film Applicator® to form the first coating layer on the glass substrate. The first resin was cured under UV light using a Hg (H) type UV lamp with minimum dose of 1000 mJ/cm 2 under nitrogen.

Copper-containing glass particles were mixed with a second resin, SFH2950, to form the second coating material. A bead of the second coating material comprising the antimicrobial material was applied along the same edge of the first coating layer on the glass substrate and subsequently drawn down using a 1.5 mil Bird Film Applicator® to form the second coating layer on the first coating layer. The vacuum was released, and the glass substrate with the composite film disposed thereon was removed from the screen separator and then cured under UV light using a Hg (H) type UV lamp with minimum dose of 1000 mJ/cm 2 under nitrogen.

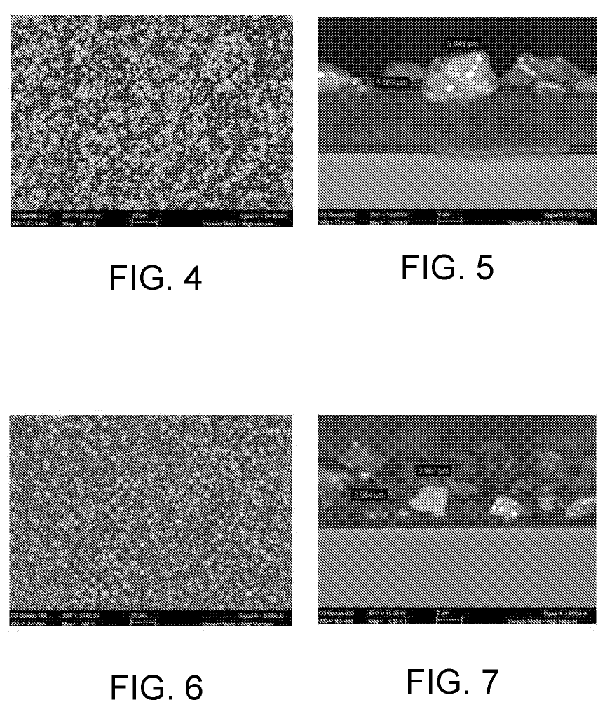

FIGS. 4-5 are top and cross-sectional scanning electron microscope (SEM) images, respectively, of the composite film prepared as described in Example 7. FIGS. 6-7 are top and cross-sectional SEM images, respectively, of the composite film prepared as described in Example 6. FIGS. 4-7 demonstrate that the surface-oriented antimicrobial composite films prepared as described herein enable the antimicrobial material particles that are evenly distributed and exposed on the composite film surface. FIGS. 5 and 7 further demonstrate that the antimicrobial particles are disposed predominantly on the surface of the composite film.

The antimicrobial efficacy of the composite films was evaluated using the procedure describe in Gross et al., Copper-containing glass ceramic with high antimicrobial efficacy, Nat Commun. 10(1), 1979 (2019).

TABLE 1
Composition of Second Coating Material and Antimicrobial Efficacy

| | Second Coating Material Composition (wt. %) | | | | | |
|---|---|---|---|---|---|---|
| | Antimicrobial Material | | | | | |
| | Copper- | | | Resin | | Antimicrobial % |
| | Containing | | Filler | Polyurethane | Polysiloxane | kill |
| | Glass | Cu₂O | Silica | (Eleglas ™) | (SFH2950) | (Staph A.) |
| Example 1 | — | 10 | — | 90 | — | <10 |
| Example 2 | — | 30 | — | 70 | — | <60 |
| Example 3 | 10 | — | — | 90 | — | <10 |
| Example 4 | 30 | — | — | 70 | — | >99.99 |
| Example 5 | 50 | — | — | 50 | — | >99.99 |
| Example 6 | 70 | — | — | 30 | — | >99.99 |
| Example 7 | 100 | — | — | — | — | >99.99 |
| Example 8 | 10 | — | 50 | 40 | — | >99.9 |
| Example 9 | 30 | — | 30 | 40 | — | >99.99 |
| Example 10 | 50 | — | — | — | 50 | >99.9 |

It will be apparent to those skilled in the art that various modifications and variations can be made without departing from the spirit or scope of the claimed subject matter. Accordingly, the claimed subject matter is not to be restricted except in light of the attached claims and their equivalents.

1. A method for making an antimicrobial composite film, the method comprising:
forming a first coating layer by applying a first coating material to a surface of a substrate, the first coating material comprising a first resin; and
forming a second coating layer by applying a second coating material to a surface of the first coating layer such that the first coating layer is disposed between the substrate and the second coating layer, the second coating material comprising a second resin;
wherein the second coating material comprises an antimicrobial material dispersed in the second resin, and a concentration of the antimicrobial material in the first coating material is less than a concentration of the antimicrobial material in the second coating material;
wherein the first coating layer and the second coating layer cooperatively define a composite film disposed on the substrate, the composite film comprising an outer surface and an inner surface, the outer surface of the composite film disposed farther from the substrate than the inner surface of the composite film; and
wherein the antimicrobial material is asymmetrically dispersed in the composite film such that the antimicrobial material is concentrated closer to the outer surface of the composite film than to the inner surface of the composite film.

2. The method of claim 1, comprising at least partially curing the first resin of the first coating layer after the forming the first coating layer and before the forming the second coating layer.

3. The method of claim 2, wherein the at least partially curing the first resin of the first coating layer comprises at least one of (a) heating the first coating layer or (b) exposing the first coating layer to ultraviolet light.

4. The method of claim 1, wherein the first resin of the first coating layer is uncured during the forming the second coating layer.

5. The method claim 1, comprising forming the second coating material by mixing a dispersion comprising the antimicrobial material with the second resin.

6. The method of claim 5, wherein the dispersion comprises an aqueous dispersion.

7. The method of claim 5, wherein the dispersion comprises a thickener.

8. The method of claim 5, wherein the dispersion comprises a dispersant.

9. The method of claim 5, comprising forming the dispersion by mixing the antimicrobial material, water, a thickener, and a dispersant.

10. The method claim 1, wherein the antimicrobial material comprises copper-containing glass particles.

11. The method of claim 1, wherein the antimicrobial material comprises copper oxide particles.

12. The method of claim 1, wherein the first coating material is substantially free of the antimicrobial material.

13. The method of claim 1, comprising at least partially curing the composite film.

14. The method of claim 13, wherein the at least partially curing the composite film comprises at least one of (a) heating the composite film or (b) exposing the composite film to ultraviolet light.

15. The method claim 1, wherein a thickness of the second coating layer is about 1 μm to about 100 μm.

16. The method of claim 1, wherein a thickness of the second coating layer is within about 10% of a mean diameter of the antimicrobial material.

17. A method for making an antimicrobial composite film, the method comprising:
forming a first coating layer by applying a first coating material to a surface of a substrate, the first coating material comprising a resin; and
forming a second coating layer by applying a second coating material to a surface of the first coating layer such that the first coating layer is disposed between the substrate and the second coating layer;
wherein the second coating material comprises a dispersion comprising an antimicrobial material, and a concentration of the antimicrobial material in the first coating material is less than a concentration of the antimicrobial material in the second coating material;
wherein the first coating layer and the second coating layer cooperatively define a composite film disposed on the substrate, the composite film comprising an outer surface and an inner surface, the outer surface of the composite film disposed farther from the substrate than the inner surface of the composite film; and
wherein the antimicrobial material is asymmetrically dispersed in the composite film such that the antimicrobial material is concentrated closer to the outer surface of the composite film than to the inner surface of the composite film.

18.-20. (canceled)

21. An antimicrobial composite film comprising:
a polymeric matrix; and
an antimicrobial material asymmetrically dispersed in the polymeric matrix such that the antimicrobial material is concentrated closer to an outer surface of the composite film than to an inner surface of the composite film.

22. The method of claim 1, wherein the antimicrobial material comprises copper-containing particles.

23. The method of claim 1, wherein the antimicrobial material comprises copper salt particles.
